(19) United States
(12) Patent Application Publication
(10) Pub. No.: US 2012/0084154 A1
(43) Pub. Date: Apr. 5, 2012

(54) APPARATUS, SYSTEM AND METHOD FOR REAL-TIME CONTENT MANAGEMENT FOR PRINTING ON MEDIA

(76) Inventor: David Andrew Dresner, Glencoe, IL (US)

(21) Appl. No.: 13/250,959

(22) Filed: Sep. 30, 2011

Related U.S. Application Data
(60) Provisional application No. 61/388,341, filed on Sep. 30, 2010.

(51) Int. Cl. G06Q 30/02; G06Q 40/00

(52) U.S. Cl. 705/14.66; 705/39

(57) ABSTRACT

The present disclosure describes a networked system of printers capable of printing programming in real time. Particularly, one implementation involves a network of printers coupled with a network that may obtain programming from a network location and print that programming on a beverage sleeve. The programming may be pre-defined and scheduled, may be targeted based on characteristics associated with a transaction, such as the characteristics or demographics of the consumer, time of day, geographic location and the like, and may be based on other information.

### CROSS REFERENCE TO RELATED APPLICATION

The present non-provisional utility application claims priority under 35 U.S.C. §119(e) to U.S. Provisional Patent Application No. 61/388,341 titled “Method for Imprinting Sleeves for Drinking Vessels,” filed on Sep. 30, 2010, which is hereby incorporated by reference herein.

### TECHNICAL FIELD

Aspects of the present disclosure relate to systems, methods and apparatus for real-time content delivery and printing on a food or beverage medium such as, but not limited to, a beverage sleeve, a coaster, a pizza box and carry-out containers.

### BACKGROUND

Drinking vessels such as coffee cups, beer mugs, drinking glasses and bottles are often formed of materials having relatively high heat transfer coefficients such as paper, plastic, glass, metal and ceramic. It has long been recognized that if such a vessel does not have a handle, it can be uncomfortably hot to handle. Moreover, it is often the case that it is desirable to keep the beverage warm or cold as long as possible. Thus sleeves of thin, flexible material such as paper, cardboard, felt, leather and the like have been used in combination with such a vessel for insulation as well as to absorb or to block passage of condensation moisture resulting from cold beverages, or to insulate the vessel in order to keep it cool.

It has been recognized that information, messages, advertisements, warnings, bar codes, and the like can be printed on sleeves. Moreover, sleeves are a particularly valuable medium for conveying information because the sleeves provide a captive medium to consumers. In fact, NOP World (purchased by GfK), a market research firm, claimed that the medium has a 65% recall rate among users of the sleeves. Furthermore, it is known that the average hot drink consumer holds on to their cup for about 50 minutes.

Currently, however, printing on food and beverage medium (e.g. coffee sleeves and paper coasters) is carried out by a centralized model of manufacturing and printing according to which the retailer purchases sleeves that are manufactured and printed by the supplier and then shipped to the retailer pre-marked. Moreover, the retailer typically maintains an inventory of such products that is exhausted slowly over time. The retailer typically must order a substantial number of pre-marked food and beverage media because of the printing processes involved which often require large volume runs, and changing messages entails ordering an undesirably large number of such media bearing a particular message, this places further undesirable delay to receive the revised media, as well as the liability of wasted inventory surplus also includes the previous or current order. Therefore, while it is possible to customize content of the media marking according to this model, a customized message still often requires placement of an undesirably large order, waste of product when the message becomes irrelevant, no ability to tailor the message to current events, too long a delay until receipt or use of the media, or some combination thereof. Because of the difficulty in customizing a given media as well as the time delays in receiving any order, it is often the case that sleeves and other mediums are simply a sunk cost, and the retailer simply marks the sleeve, pizza box, or the like with content about itself.

It is with these various issues in mind, as well as other, that various aspects of the present disclosure were developed.

### SUMMARY

One aspect of the present disclosure involves a method for delivering targeted information to a consumer comprising obtaining, at a computing device associated with a printer, programming to print on a food or beverage medium such as a beverage sleeve (e.g., insulated coffee sleeve), a beverage coaster, a food package and an ice cream sleeve. .Contemporaneously with a consumer receiving a product or in association with a transaction, the method further involves printing the programming on the food and beverage medium for distribution to the consumer with the product. The programming may be obtained form a remote server or database. Thus, the method may involve, amongst may other operations, in response to an electronic transaction associated with a food or beverage purchase, accessing a remote server to obtain the programming to print on the food and beverage medium.

In another aspect, a system for managing information for printing on a beverage sleeve is described. The system includes at least one computing device in operable communication with a printer and a network. The at least one computing device may be configured to receive programming for the printer to print on a food and beverage medium. Further, the at least one computing device may be configured to receive the programming based on a transaction proximate the printer. Finally, the at least one computing device may be configured to receive the programming from at least one computer accessible source of programming to print on the beverage sleeve, the at least one computer accessible source of information in operable communication with the network. The source of programming may include a network accessible application configured to allow a user to create the programming. Further, the source of programming may include a database accessible through the network, the database storing the programming.

It is to be understood that both the foregoing general description and the following detailed description are explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The foregoing and other objects, features and advantages of the inventive concepts set forth herein will be apparent from the following description of particular embodiments of those inventive concepts, as illustrated in the accompanying drawings in which like reference characters refer to the same parts throughout the different views. The drawings are not necessarily to scale; emphasis instead being placed on illustrating the principles of the inventive concepts.

FIG. 1 is a diagram illustrating one possible system and methods conforming to aspects of the present disclosure;

FIG. 2 is an isometric view of a coffee sleeve conforming to aspects of the present disclosure;

FIG. 3 is an isometric view of the coffee sleeve illustrated in FIG. 2;

FIG. 4 is a top view of the coffee sleeve illustrated in FIG. 2;

FIG. 5 is a bottom view of the coffee sleeve illustrated in FIG. 2;

FIG. 6 is a side view of the coffee sleeve in a substantial flat configuration suitable for printing and prior to expanding as shown in FIGS. 2-5;

FIG. 7 is a top view of the coffee sleeve shown in FIG. 6;

FIG. 8 is a block diagram of a web server and sleeve content management application conforming to aspects of the present disclosure;

FIG. 9 is a flowchart illustrating a method of defining, designing and editing content (programming) for a coffee sleeve or other food and beverage media conforming to aspects of the present disclosure;

FIG. 10A is a diagram illustrating a coffee sleeve blank and illustrating channels on the blank where programming may be printed according to aspects of the present disclosure;

FIG. 10B is a diagram illustrating a coffee sleeve blank and illustrating channels on the blank where programming has been printed according to aspects of the present disclosure;

FIG. 10C is a diagram illustrating a coffee sleeve blank and illustrating channels on the blank where programming has been printed according to aspects of the present disclosure;

FIG. 11 is a flowchart illustrating a method of scheduling, approving, and/or paying for programming;

FIG. 12 is a diagram of an electronic calendar configured to manage and schedule sleeve content printing;

FIG. 13 is a flowchart illustrating a method for an advertiser or other third party to schedule sleeve printing, such as in a campaign, according to aspects of the present disclosure; and

FIG. 14 is a diagram illustrating a mobile website that may be implemented in accordance with aspects of the present disclosure.

### DETAILED DESCRIPTION

The present disclosure describes systems and methods for brand extension, managing inventory, generating social capital, targeted advertising, revenue generation, advertising campaign management, coupon distribution and management, geographic content delivery, public safety messages and other actions, through mediums, and packaging as well content management and real time printing of content on food and beverage mediums and packaging as well as other media. In this description, primary, attention will be given to an embodiment addressing coffee sleeves; however, the systems and methods described herein are applicable to numerous other possible food and beverage mediums such as coasters, other beverage sleeves, pizza boxes and other carry out or food delivery containers, or other disposable products such as packaging boxes, ice cream sleeves, cup cake sleeves, etc.

The systems and methods discussed herein provide a completely new paradigm for the local café, the national coffee chain, advertisers, and consumers to interact, advertise, manage inventory, generate revenue, as well as many other advantages. In a conventional setting when a consumer enters a local coffee shop to purchase their morning coffee, the barista serves their cup of coffee in a paper cup with an insulated sleeve that has pre-printed information—typically the name of the café or is blank. Under the present system, however, the customer is given a sleeve that may include personalized information, such as an advertisement targeted specifically for them or their demographic, a coupon for an item in the café that the owner is promoting, an advertisement and coupon for a shop in the vicinity of the cafe, a bar code or two-dimensional matrix (matrix) code (e.g., a QR code), or other information. The information provided on the sleeve may be temporarily relevant, programmable by a third party (e.g., and advertiser) and may also be targeted to the consumer. The system may also provide a method for tracking the usage of the sleeve, by way of hyperlinks, QR conversion, contest tracking, inventory controls and otherwise. This system can also be used as a local early warning system for the government or safety organizations and for issuing Amber alerts.

In one possible example, the system identifies a characteristic of the customer, such as their name, gender, age, time-of-day, geography, etc., and obtains information targeted to that customer based on the characteristics. For example, the system may be linked to a point of sale system, and when a credit card is processed the customer information is obtained. In another example, the consumer may load an app or other application onto their smart phone that automatically interacts with the system through a wireless connection. When the particular customer is identified, the system may include or have access to a customer database with information pertaining to particular customers, a demographic database and application including information directed toward particular demographics, a database of purchasing history for the customer at the particular retailer as well as other purchasing history, as well as other applications and databases. If, for example, the customer demographic information suggests the customer would be interested in certain information (e.g., car advertisements, sports scores, a QR code link to news, a coupon to a local hair salon, etc.), then that information is provided to a coffee sleeve printer at the coffee shop and the information is printed on a coffee sleeve that is given to the customer with her coffee.

The method of identifying a characteristic of the customer or the particular customer herself may be done through an optical scanning/picture feature, where the customer is photographed or scanned or otherwise imaged prior to receiving their printed content. Additionally, the customer can elect to scan their mobile computing device at a system node (e.g. printer with a reader or stand alone device) and according to their preferences, either predefined or algorithmically, the relevant content is provided on the beverage or food medium. Additionally, the printed information may include coupons or other redeemable rewards that can be converted or otherwise redeemed at the node in the system. This provides a proactive and redeemable medium for businesses to attract customers in real-time.

The sources of information to print on the sleeve, however, are vast and varied. The information may be part of a highly-local, local, regional, or national advertising campaign. For example, a car company may be releasing a new model with both front wheel drive and all wheel drive and various option packages and associated pricing levels. With such a campaign, the system can take into account various combinations of factors including the particular customer and their specific information and demographics, the location of the purchase, the time of day, etc. The system may then determine to print an advertisement for the all wheel drive version at a Colorado coffee shop location and the front wheel drive version in a Florida coffee shop location. The system may further determine whether to print information about the various possible options and pricing levels based on the customer demographic and other factors. The system may also be very locally tailored allowing, for example, a new salon to provide information to the system so that coupons or advertisements for the new salon are provided on sleeves at participating coffee shops within a one mile radius of the salon. The location for the beverage medium printing can also occur and be controlled by the final location of the node/printer. Therefore, a sleeve content management application and some functionality would not rely on a network, but functioning on a single owner/input basis not necessarily coupled with a network.

On the Internet today, there is a constant stream of news, stories, content, updates, tweets, social network feeds, RSS feeds, blog posts that are being transferred in real-time between sites, users, and applications. Aspects of the present disclosure are able to print such information and print on advertising mediums in a networked printer system. This information can be customized based on the user inputs, to which, can be personal twitter accounts, Facebook™ news streams, demographic presorted, geographically based, store specific content that is delivered in real-time for printing. The transition from online media to a physical medium is a new front where users will also be able to create, publish, participate and schedule content on beverage sleeves and other food and beverage media. In the current climate of social deals, consumers are attracted to deals based on their interests and behaviors. The present disclosure can be extended to this area of interaction between consumers and aggregate deal providers to deliver coupons in real-time to anyone purchasing a beverage or otherwise.

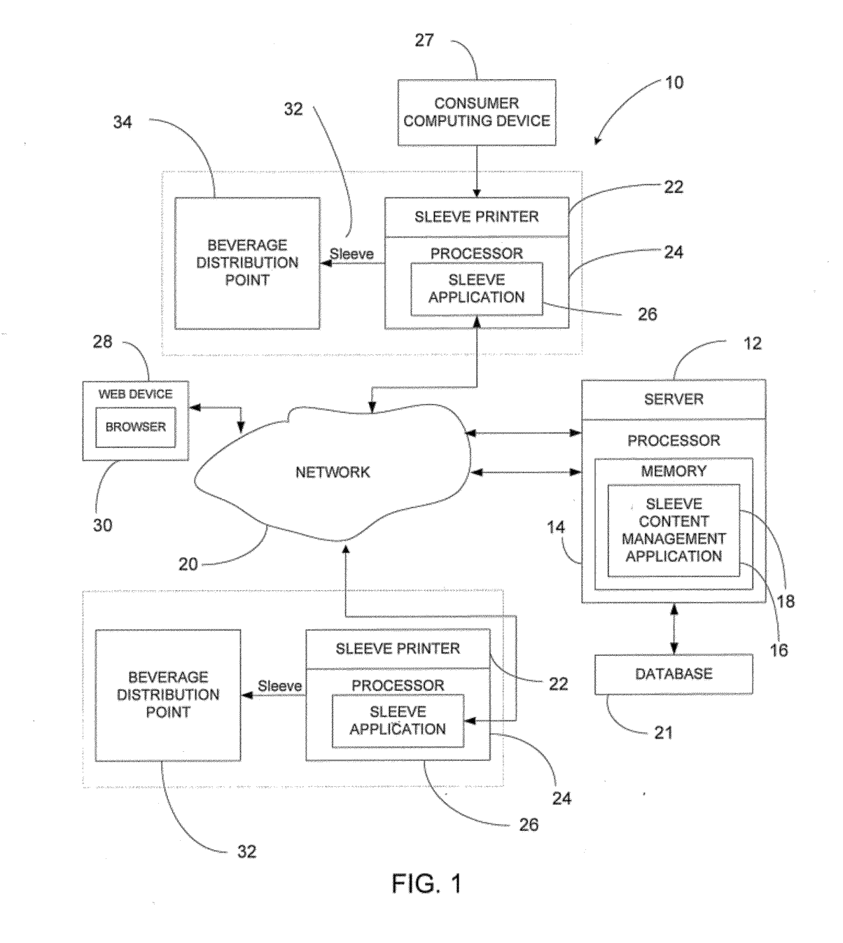

Referring now to FIG. 1, a system 10 conforming to aspects of the present disclosure is shown. The system includes a server 12, such as a web server, including a processor 14 and memory 16 suitable to host and run a sleeve content management application 18, accessible through a network 20, such as the Internet. The server may be coupled with or otherwise in communication with a database 21 storing consumer information, demographic information, sleeve content, sleeve calendars, and other information and data, discussed herein, useful for implementing various aspects of the systems and methods. The network may be wired or wireless, or combinations of the same. At a retail location, or other location, such as a coffee shop, or geographically proximate such a location, a sleeve printer 22 is provided and it is coupled with a processor 24 running a sleeve application 26 that controls what information is printed on a given sleeve. The sleeve application 26 may also include some or all functions of the sleeve content management application 16 depending on the particular implementation and depending on whether the printer or sleeve application includes a network connection. The node or printer may be equipped with near field communication (NFC), global positioning systems (GPS), 3G or 4G communications, WiFi, a dual band wireless N router, and other such devices to provide a connection to the network as well as connections with other devices. The sleeve application 26 at the printer location is configured to communicate with the sleeve content and management application 18 at the web server 12. Alternatively or additionally, the sleeve application 26 may allow the printer to process transactions as a stand alone or self service node. For example, the printer may include a touch screen with sleeve programming choices such that a user may select the sort of programming that will be printed on her sleeve. A facility may include one or more printers with a range of functionality.

A user at a café interacting with the sleeve application through a consumer computing device 27 (e.g., a smart phone, tablet, etc.) or a user at a device 28 with a web browser 30, whether at a coffee shop or otherwise, may access the sleeve content management application and define the information that will be printed on a sleeve 32 by the sleeve printer 22 and placed on a cup of coffee or other beverage at a beverage distribution point 34 (e.g., café). The consumer may also process transactions, redeem coupons, access links, etc., by interacting with the printer or system node as well as the remote server 12 by way of the network

The sleeve printer 22 may be any form of printer suitable to print on a coffee sleeve, coaster, pizza box or the like. For example, the printer may be an ink jet printer, a laser printer, an ink jet printer or a thermotransfer printer as well as others. Alternatively, the printer may be a thermal printer, such as a theromdirect printer, that does not deposit ink on the sleeve but rather uses heat to interact with a direct thermal coating deposited on the sleeve. In one particular arrangement, coffee sleeves are coated with a direct thermal coating and thermochromic pigment mixed with a polyvinyl alcohol. One suitable coating is an activator coat with DT9242 grade, which is a translucent direct thermal coating available from NuCoat™. In such a system, blank coffee sleeves are supplied with the proper thermal coating. Using a thermodirect printer, the cafe or other location has the advantage of not having to maintain a supply of ink, change ink cartridges and the like.

The printer, which may be a stand alone node of the system, may also be configured to provide real-time content to a user via GPS, web or mobile application and/or NFC. For example, if a user uses a mobile device including GPS, the system may obtain GPS information from the mobile device and provide programming based thereon. The printer may be configured with an optical scanner or imaging device. With such functionality a consumer can take their mobile device and “bump”, scan or wave their device over the printer or node's optical scanner or reader, pay for subscriptions to digital goods, including, but not limited to newspapers, magazines, games, stories, blogs and social networks. For example, the Wall Street Journal™ can deliver content via the described system of printers, so that, in addition to printing stories or news headlines on the sleeves, the system and printer can provide additional content to the user, via paid or free delivery or subscriptions. Instead of a user paying for the physical paper or paying everyday for digital delivery, the content can be paid and delivered in a relevant and convenient scenario, such as when drinking coffee at a café.

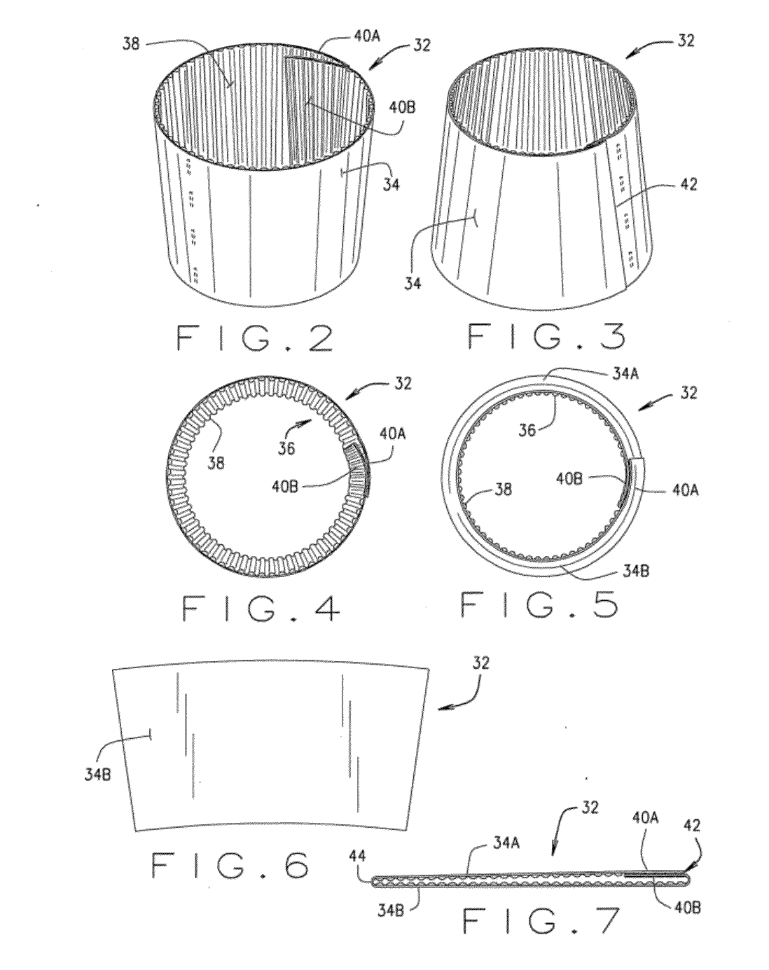

FIGS. 2-7 illustrate a particular sleeve 32 that provides greater and improved printable surface area and facilitates the ability to print on a sleeve, particularly at a printer location such as a café or other food and beverage outlet where the staff may not be accustomed to managing sophisticated printing equipment. The sleeve material may be single phase corrugated paper, chip board, solid bleach sulfate, fluted paper, bamboo, and layers of some or all combinations, as well as other materials. Sleeve forms a truncated cone when expanded into a form suitable to fit over a conventional disposable paper coffee cup. The sleeve is formed of a paper based product and may have a thermochromnic coating on an outer flat and smooth surface 34 (liner). The inner surface 39 (fluting/medium) which contacts an outer surface of a coffee cup, includes a fluted insulation layer 38.

The fluted insulation, at adjoining ends (40A, 40B) of the sleeve, is compressed, and the compressed portions are glued or otherwise affixed to form the circumferential truncated cone-shaped sleeve. While both the inner and outer adhered end areas are shown compressed, it is also possible to compress only the outer portion 40 of the sleeve. In any event, the inner and outer compressed areas overlap along the compressed areas. For shipping and printing, the sleeve is folded at a seam 42 formed where the compressed sleeve ends are affixed and also folded at a dimensionally opposite area 44 so that, as shown in FIGS. 6 and 7, two substantially flat and smooth sleeve surfaces (34A, 34B) are available for printing a message or other information. In forming the sleeve in this way, the seam has a lower profile as compared with other sleeves where no such compression is provided. Moreover, by folding the sleeve adjacent the seam, the smooth and flat surface areas of the sleeve are increased and maximized relative to a sleeve formed in other manners.

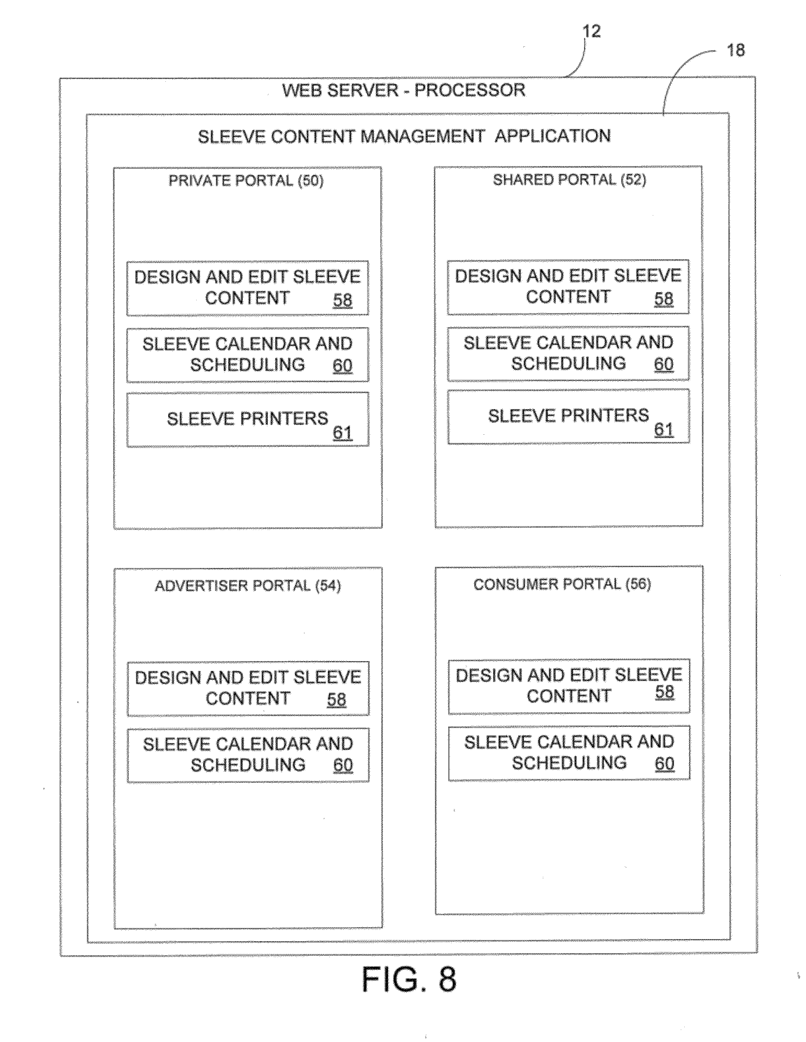

Turning now to the computer applications that facilitate creation of sleeve content and management of printing that content on the sleeves, FIG. 8 illustrates the sleeve management application 18 and related portals accessible by way of the application and provides access to various functions of the sleeve management application. In one possible arrangement, referring to FIG. 1, the sleeve management application involves computer executable instructions running on the web server 12 coupled with the network 20. Accordingly, a computing device 28, such as a personal computer, laptop, tablet, smart phone, or the like, that includes a browser, a dedicated application, or otherwise and a connection with the network (e.g., 3G, 4G, WiFi, etc.) or other means of accessing the sleeve content management application may access the application. Thus, for example, a cafe owner may access the application 16 to define content for sleeves to be printed at the cafe, an advertiser may access the application to define and manage a sleeve-based advertising campaign that will be printed on sleeves at any number of possible cafes, an individual consumer may access the application to define and order a message for another consumer, and otherwise. With the system 10, any number of imaginable scenarios is possible where print content may be defined, scheduled and otherwise managed through the sleeve content management application.

In the example shown in FIG. 8, the sleeve content creation and management application includes four different portals (private portal 50, shared portal 52, advertiser portal 54, and consumer portal 56) that provide different functionality to create content for sleeves, to define sleeve campaigns, to manage printers, to schedule sleeve content printing and perform other functions. Common to the various portals, is an application that provides for the creation of sleeve content, managing the presentation of that content on sleeves, and monetize some portion of the food and beverage medium. Thus, the various portals may provide access to the common functions and allow other interaction with such functions.

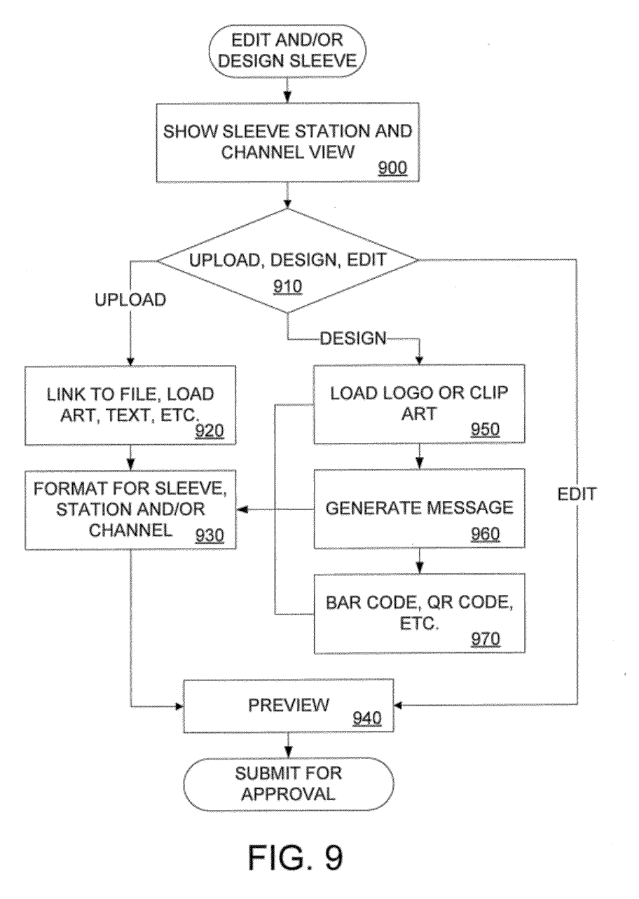

FIG. 9 is a flow diagram illustrating one possible method of defining content for a sleeve. This method, or portions thereof, may be applicable to various possible entities or individuals using the system. For example, café owners, managers, advertisers, and individual consumers may all use various aspects of the method, as well as other methods and systems discussed herein. Additionally, this method or portions thereof may be accessed thorough different portals. For example, each portal provides a link to “design and edit sleeve content” 58 that links the user to various functions to design and edit sleeve content. The method may be implemented at the sleeve content management application 16, the sleeve application 26, or otherwise.

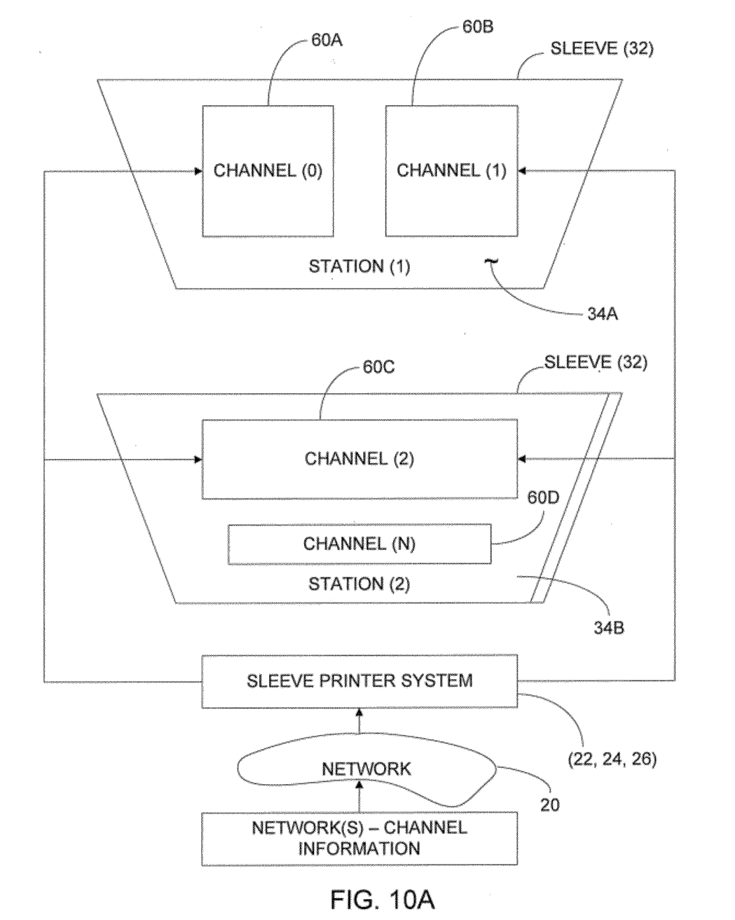

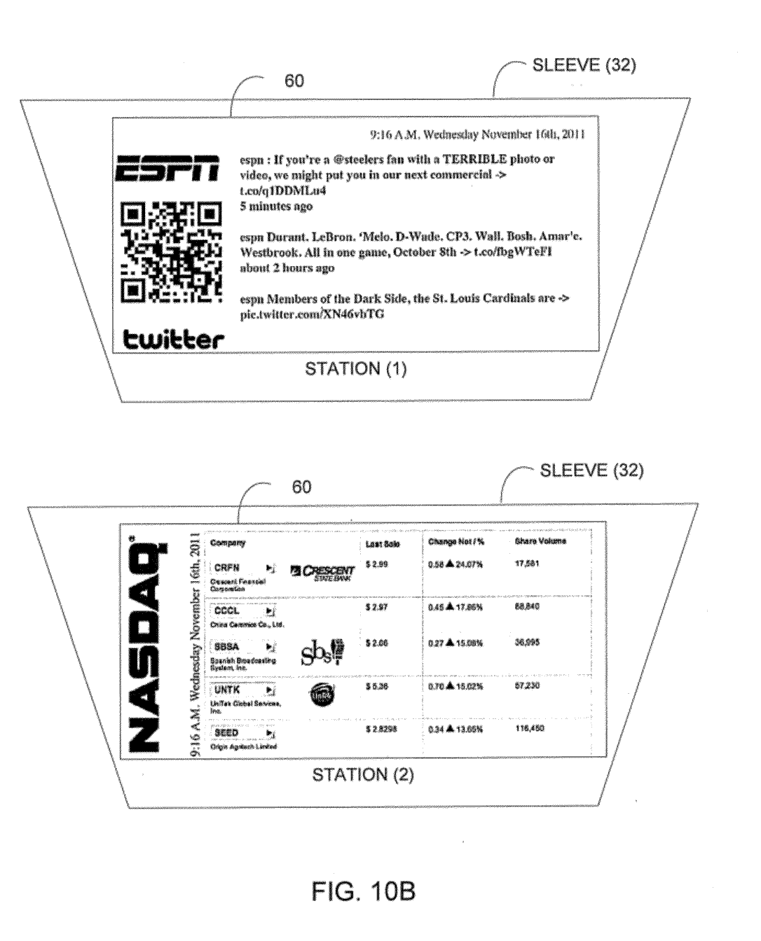

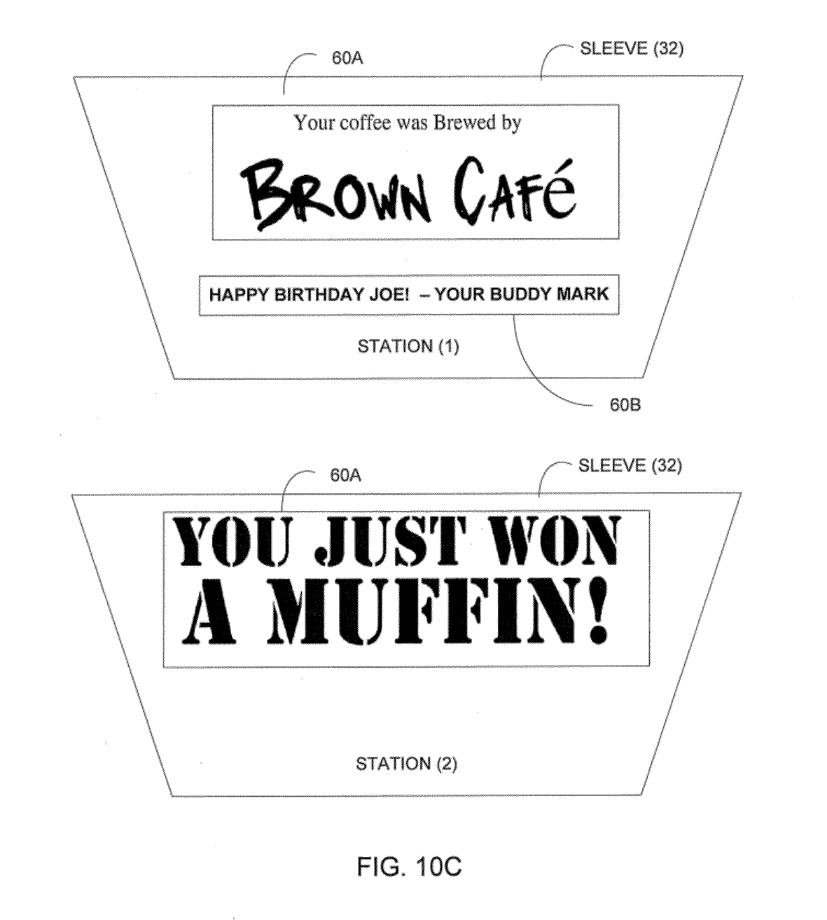

At the beginning of the process, a sleeve station and channel template is presented (operation 900). FIG. 10A is a diagram illustrating a first side 34A and second side 34B of the sleeve 32. As discussed herein, a sleeve may have two stations on opposing sides of the sleeve. A station is the physical location on the sleeve where messages or other information may be printed. In the case of the sleeve illustrated in FIG. 10A, the sleeve has two stations representing the printable portion of each half (34A, 34B) the sleeve. As discussed herein, the sleeve is folded and glued to form two substantially equalized sized portions. For a pizza box, the outer portion of the cover may represent a station and the inner portion may represent a station. Further, other portions of the box may represent additional stations with each station having different possible numbers and sized channels. Each station may include one or more channels 60 where messages or other information is actually printed on the sleeve. The size, shape and/or position of a channel within the station may be defined in the content creation application accessible through the various portals or otherwise. For purposes of illustration, the first station is shown with two equally sized rectangular channels (60A, 60B) positioned side-by-side. The second station is shown with a third rectangular shaped channel 60C above a smaller fourth rectangular shaped channel 60D. In this system, there are other printable or thermal direct mediums that can be provided, such as, stickers that are coated with thermal direct coating where information is printed.

Referring to FIGS. 8-10C among others, the sleeve channels 60 may be pre-populated with content or may be blank. For example, when a café accesses the sleeve content creation application 16 from the private portal 50, one or more of the sleeve channels may be pre-populated with default content such as the café's logo and a slogan. The logo may occupy one channel and the slogan another channel, or the logo and slogan may be present in the same channel, or other arrangements are possible depending on the configuration of the system. It is also possible that a café may reserve a channel or entire station for internal use and may make another channel or station available to third parties for use and scheduling. When an advertiser accesses the sleeve content application form the advertiser portal 54, a blank template may be presented, the most recently defined or edited content may be shown, or other information may be present in the initial template. Regardless of the sleeve template view and whether or not information is pre-populated, the user can define the content provided in a given channel. For reference, FIGS. 10B and 10C are examples of sleeves with programming shown in the channels prior to printing. This programming might pre-populate the channels or may be the result of the various operations discussed herein for defining programming.

In the method shown, the application provides three options for the user—uploading pre-existing content, defining new content, or editing existing content (operation 910). While those operations are shown, the application allows the user to design and edit a sleeve using any combination of available options. Moreover, other options and design steps may be added or removed. To upload existing content, the application allows the user to link to an existing file present on the user's computer (device being used to access the application) and/or allows the user to access a file stored remotely, such as accessing a file coupled with the sleeve application (operation 920). For example, the user may load image files, such as .bmp, .jpg, .tiff, vector images, raster images, or other image files, text files, or the like. Regardless of the selected file type, the application sizes the file for presentation on a selected channel (operation 930) and presents the content in a selected channel for preview (operation 940). The user may also provide information to the printer that allows the printer to provide relevant content; the user may link Facebook™, for example to the system application on the mobile device and can scan the mobile device, identification card, credit card, gift card, debit card, and the like, and print their recent Facebook™ stories.

Additional operations may be available when a user decides to design content rather than uploading existing content. It is certainly possible to also use existing content or files to initiate the content design process and then add to or alter the existing content. In any event, the user has several options to define content for a channel. For example, the user may load or otherwise select an existing logo or trademark file (operation 950). Similar to the method discussed above, the user may access existing logo or trademark files and upload them for presentation in a channel. The application may automatically size the file for an existing channel or the user may customize the size of the file presentation within a channel (operation 930).

The user may also define a message to display in a channel (operation 960). For example, the application may present a word or text editor that allows the user to enter a message, define font type and size, as well as perform other common text editor functions. The text editor may also allow text wrapping and autosizing based on the channel size. The user may also define the size and shape of a window in which the text is presented. So, for example, if the user is constructing a message for a particular channel, the user might select a logo and size that logo for presentation in a portion of the channel and the user may also define a text window within the same channel where a message is presented adjacent the logo. The user may then edit the content selection, such as by selecting a new file to replace the previously selected file or adding to the previously selected channel, the size and shape of the channel, such as be using a mouse to select the shape and alter its dimensions, or make other changes. The user may continue to edit the content and channel(s) until she is happy and then select submit.

The user also may define other content or information to present in a channel. The various types of different information that may be presented in a channel may collectively be referred to herein as “programming.” For example, the user may include a coupon, bar code or QR code within a channel (operation 970). In the case of an individual café or salon in the neighborhood of the cafe, the user may use coupons to manage inventory in real-time. For example, the café may define and schedule 50% off coupons to help sell remaining inventory with a shelf life. In the case of a salon with a cancellation, for example, a user may, in real-time schedule 50% off coupons for a hair cut at the time of the cancellation.

As introduced above, a QR code may allow a user to link to information from any network accessible device having a QR code reader. In one possible example, a smart phone with a camera may have a QR code reader, and when the user photographs the QR code, the application reads the code and automatically launches a browser on the smart phone and links to a network site address, such as a site on the Internet. Hence, a user may define a QR code that is printed on the sleeve and the user may also define what site the consumer is linked to and what information is present at the site.

Regardless of the programming defined for a channel, when the programming information is complete, the application allows the user to preview the channel content (operation 940). So, for example, the application displays a logo, message, QR code, etc., in one or more defined channels and allows the user to accept or further edit the channel and its content.

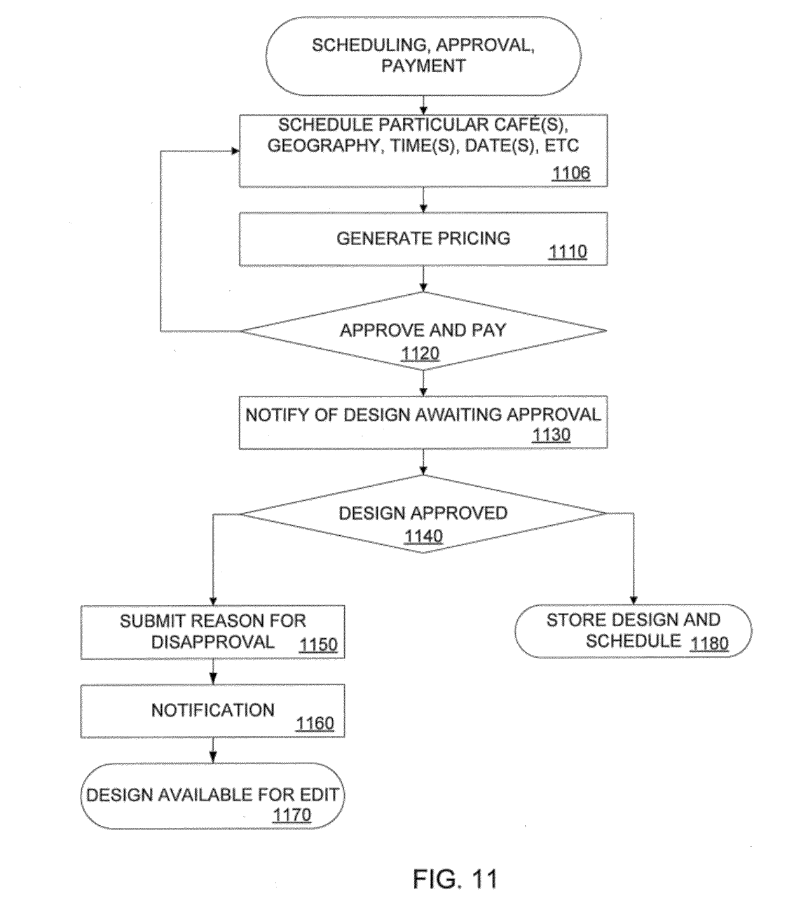

Selecting submit or otherwise completing the operations of defining and designing the sleeve content, submits the channel content for scheduling, payment and approval, among other things, in one possible implementation (operation 950). Referring now to FIG. 11, a flowchart is shown illustrating some of the possible operations when a user submits a completed content design. To begin, the user, whether a café, an advertiser, an individual or otherwise, may schedule printing of sleeve content or delivery of pre-printed sleeves (operation 1100). In some implementations, pricing and approval depends on information entered or otherwise obtained during scheduling.

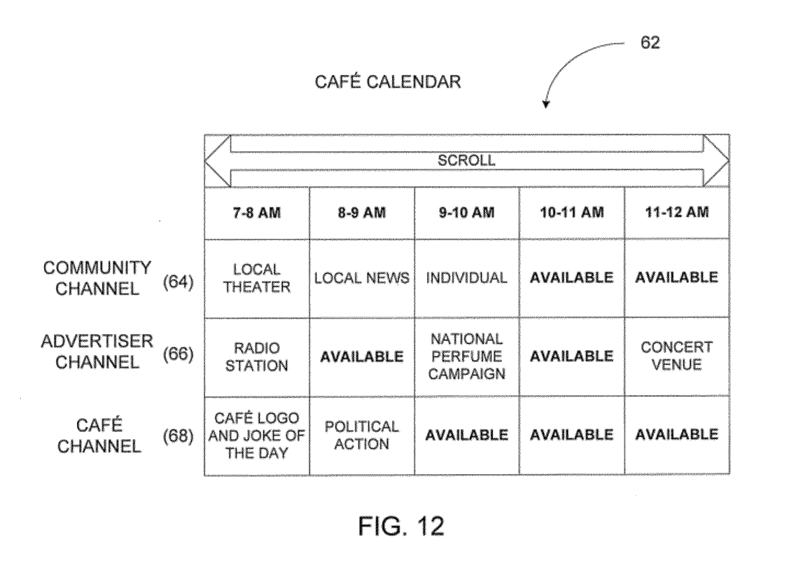

Scheduling through the private portal or other portal, such as scheduling by an individual café, involves selection of the scheduling link 60 and presentation of an inter-active sleeve calendar 62. FIG. 12 is one example of a possible calendar 62 for use by an individual café and thereby specific to sleeves printed at the cafe. Other interactive calendars may also be provided for scheduling sleeve printing on a geographic basis, chain basis, demographically, etc. Moreover, various possible interactive calendars may be populated through user interactions across the various portals. For example, when a third party advertiser schedules an advertising campaign, the campaign may populate calendars for various cafes. In another example, a chain wide calendar may be provided such that when it is used for scheduling some or all individual cafe location calendars will be populated. The system may be configured to reserve certain channels for various possible uses so that pre-population is managed. It is also possible for the system to prohibit access to various calendars. Regardless, the interactive calendar disclosed in FIG. 12 and discussed with reference to scheduling content for three channels available at a local cafe is simply one possible example and is meant as an illustration of one possible example of a scheduling function.

In the example of FIG. 12, the calendar shows hourly time columns and three channels of information for each hour. Here, the café has defined three programming sources—community 64, advertiser 66, and café 68. In this example, the community channel is available at one pricing level and is limited to only non-profit or local organizations, the advertiser channel is available for purchase at a second pricing level, which may be greater than the first pricing level, and is available to any third party advertiser, and the cafe channel is reserved for use by the café. The calendar may be linked to the number of channels that the café designates for its sleeves. The system may provide a default sleeve channel design. However, the system may allow the café or other user to add or subtract channels from the sleeve stations. Moreover, the system allows a user to restrict access to certain channels and set pricing for channels. The calendar may also be linked or otherwise show other channels available on its sleeve but managed or otherwise configured by another party.

Referring to the sleeve illustrated in FIG. 10, a third party that manages, extends and maintains, the system 10 (FIG. 1) may control or otherwise access the first station and the channels (e.g., channels 60, 60B) available on that station and the café may control or otherwise manage the second station and associated channels (e.g. channels 60C, 60D) available on the sleeve. In any event, the calendar shows the times that various channels have been scheduled and those times that are available. Thus, for example, the community channel 64 is scheduled to print local news between 8-9 A.M. defined manually by pasting news headlines into a text window or using the method illustrated in FIG. 9 a user may generate news content (programming) in several ways. News content defined with QR code with an encoded link to an Internet site of local news. It is also possible that a news organization may define news headlines at a network accessible location, and the system is configured to upload the information at the link and control the printing system (22-26). In such an implementation, the user would, at operation 970, define a link where to load content for a channel, and the sleeve application 16 (FIG. 1) is configured to access the information at the link and format it automatically for the designated channel and then transmit the information to the sleeve application 26, in one example. Referring again to FIG. 12, during the 9-10 AM time block, the advertiser 66 and café 68 channels are available or otherwise unscheduled. Thus, the café owner may use the interactive calendar 62 to schedule sleeve content during the 9-10 AM time block. In one example, when the user selects the calendar time and channel, the application launches a window or other application where the user can define what content, previously defined, to schedule for printing. Alternatively, during the operations discussed with reference to FIG. 10 or 11, the user may access a link that allows the user to schedule content it is also possible that selecting a time block or channel to schedule will link the user to the application for FIG. 9 to define content. Content scheduling for a café as opposed to another may proceed in a different order as in some implementations, a third party, such as a consumer or advertiser, may be prohibited from scheduling until content is approved and/or payment is made.

In the case of some content, such as a targeted advertising campaign using demographics, programming is transmitted to the appropriate printer based on some triggering event and not a schedule. For example, when a person matching the target demographic purchases a cup of coffee, the system will detect the demographic characteristic (time of day, geographic location, age, etc.) and transmit the target advertisement to the printer where the cup of coffee was purchased. Alternatively, the printer may have the appropriate programming content stored in local memory and print the programming.

Returning to FIG. 11, once scheduling is complete, the system generates pricing (operation 1110). Program pricing may be based on several factors, including the time, date, number of cafes, type of content, geographic region, number of sleeves, deomographics, etc. For example, a single message for a particular consumer, such as if someone uses the system to buy a cup of coffee and send a message on the person's sleeve, may be one price—say $3.00. Scheduling an advertising campaign for an entire geographic region may be $0.10 per sleeve. When pricing is generated, the user may approve and pay for the purchased programming (operation 1120).

In some implementations, the system requires approval of the content (operation 1130). As mentioned herein, this allows the system manager, café owner or otherwise, to monitor and reject inappropriate programming (operation 1140). When programming is disapproved, the system requires that a reason be entered (operation 1150) and sent to the person that created the programming (operation 1160). At that point, the user may alter their programming (operation 1170). When the design is approved (operation 1140), it is stored and then transmitted to the appropriate printers according to the schedule or otherwise.

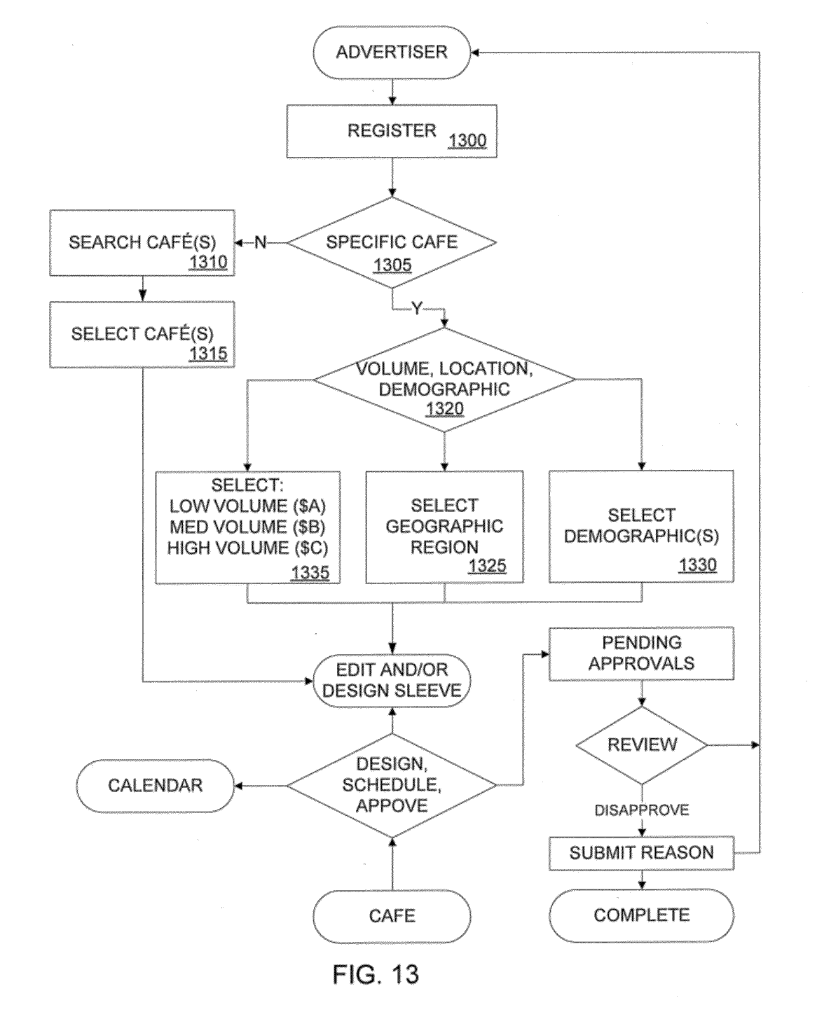

FIG. 13 illustrates a method for a third party to schedule content for any print news through the advertiser portal 54. To begin, the system provides an advertiser with an opportunity to register with the system (operation 1300). Registration may involve establishing an account or pre-establishing a method of payment, providing one or more email addresses for a point of contact with the system, establish invoicing contacts and address, as well as other possible information associated with the advertiser. Once registered or otherwise logged into the portal 54, such as with a user name and password, the system 10 allows the user to define content for a specific individual café or through other means (operation 1305). It is noted that the advertiser may first define content before scheduling content, or may schedule content and then define the content. In any event, to select an individual café, the system may allow any number of mechanisms to select a particular café, such as through a search of cafes registered with the system, a search by geography, a pull down menu or other list of previously selected cafes, etc. (operation 1310). Through any of these possible mechanisms as well as others, the system presents a list of cafes matching the search criteria and the user may select the appropriate café or cafes (operation 1315).

Should the advertiser seek to run advertisements based on other information, such as geographically, demographically, or otherwise, the system presents the user with a list of mechanisms by which to schedule content distribution to any number of cafes and/or sleeve channels. In one example, the system allows the user to schedule based on volume of sales at a café, location and/or demographics (operation 1320). To select a geographic region, the system may present the user with a map and user may zoom appropriately and select the region (operation 1325). The map may also be populated with participating or registered cafes in the selected area. As part of the registration process, each café enters location information, such as an address.

To select a demographic, the system presents the users with a list of available demographic characteristics by which the advertiser can schedule sleeve content (operation 1330). The system may store and otherwise provide demographic scheduling based on any number of possible demographics, such as age, gender, income, ethnicity, religion, sexual orientation, etc. When the user has identified its demographic characteristics, the system will automatically schedule channel content at the appropriate cafes. Moreover, the system may also provide for obtaining demographic information prior to determine the content on a particular consumer's sleeve. Hence, for example, if the, advertiser selects females between 40 and 50 living in Colorado, the system will automatically identify when a 40-50 year old female, at a registered café in the state of Colorado, purchases a cup of coffee and will send information to a printer so that a sleeve may be printed (in real time) for the targeted woman. The targeted woman may be identified simply by using assumptions—such as time of day and geographic location—to print the sleeve. Or, the system may include consumer information and make more specific determinations when printing. Availability to print targeted content on a channel will depend, possibly, on whether other information has been scheduled on the channel. It is possible to configure the system, such as through payment of a premium, to schedule certain content with a priority. So, for example, a certain channel may be designated for a non-targeted bulk advertisement. However, by paying a premium, the advertisers may ensure that system prints its targeted advertisement in place of the bulk advertisement when a person, such as the 40-50 year old female living in Colorado, makes a purchase.

In addition to geographic and demographic information, the user may also schedule channels and/or content, based on volume of traffic at a particular café, group of cafes, café chain or the like (operation 1335). For example, the system may track the volume of sales at various registered cafes, and rank or otherwise associate the cafes with traffic volume. Further, the system may charge a different rate for scheduling content and channels at cafes with different traffic volume. Hence, for example, the system may provide a first rate for high volume cafes, a second rate (lower than the first) for medium volume cafes, and third rate (lower than the first and second) for low volume cafes. Thus, an advertiser may pay a premium for scheduling content on channels that will be printed on stations in a high traffic café.

The system may also combine the various possible ways to define scheduling. For example, a user may elect to search for a particular café having a particular demographic, be located in a particular area, and be associated with a particular traffic volume. So, for example, if the advertiser elects to test a campaign at a particular café, the advertiser can search by café as well as volume designation, demographics of the café, and the like, and select a particular café matching the various criteria. The advertiser might also use a QR code to track performance of the campaign. For example, the advertiser might link a QR code to a website where the user completes a short survey in exchange for a coupon. The system may also be configured to then print that coupon on a sleeve the next time the consumer buys a cup of coffee at a registered café.

Returning to FIG. 11, after scheduling channels and/or content, the system is configured to generate pricing for the selected schedule (operation 1110) and provide a mechanism by which the user may pay for use of a channel (operation 1120). The café owner, is some implementations, may not have an additional payment obligation. A third party advertiser, however, would have such an obligation although the system can be customized to require payments based on a host of different factors and may set rates based on those factors. For example, a local non-profit organization may be provided with a low cost or free use of channel whereas a conventional commercial advertiser may have a different rate. The system may be configured to allow the user to set up an account, to set up invoicing, to participate in various plans, to pay separately for each advertisement or campaign, etc.

After some form of payment is made or otherwise established, the system submits the design for approval, in one possible implementation (operation 1130). Since it is foreseeable that someone might attempt to define or schedule, objectionable or inappropriate content, the system provides a mechanism whereby content is first approved before being printed or scheduled. Various ways to approve content may be established. In one particular implementation, the system submits, through email or through some other form of notification, that content has been submitted for approval. Approval may be obtained by the third party managing the system and/or by the individual café or cafes where the content might be printed. Hence, for example, when an advertiser defines content for an advertising campaign, the content is submitted, such as by a link to the content, in an email to an employee designated for approvals. The employee then may view and approve or disapprove of the content (operation 1140). Similarly, the system may send an email or otherwise notify any café's possibly affected by the campaign and provide an opportunity to approve or disapprove. Such features may be particularly important, when content is defined and scheduled for a particular café. In any event, when content is disapproved, the system requires that a basis for the approval be provided (operations 1150, 1160), such as through an email to the advertiser, where such designated recipient is identified in the registration process. The advertiser or other user may then enter the system and edit the content or generate new content (operation 1170). When the content is approved, the system stores the content and confirms the content scheduling or provides the user with an opportunity to schedule the content.

The café calendar may be limited to the channels on the station under the café control or the calendar may show scheduling on both channels. Since it is possible that a café may not want certain content shown sleeves available at its location, when the calendar is configured to show scheduling for a station and/or channels controlled by a third party, the calendar may include a content link so that the café can view the content scheduled by the third party and a mechanism may be available to request certain content not be printed.

The private portal also includes an application 61 that allows the user to identify and manage printers within the locations under the control of the portal host. For example, a neighborhood coffee shop may have only one printer. In contrast, a large national chain may have dozens or more coffee shops in a given geographic area. In either event, the application allows the user to designate printers available for use within the system. For example, the system may be configured to allow the café user to register a network address of the printer with the system. In one example, when the sleeve application is initially run on the sleeve printer, it will initiate a connection with the network, whether through a wireless port or a wireline port, and will allow the user to register the printer with the system through a touch screen or other input. Once registered, the private portal allows the café to provide additional information.

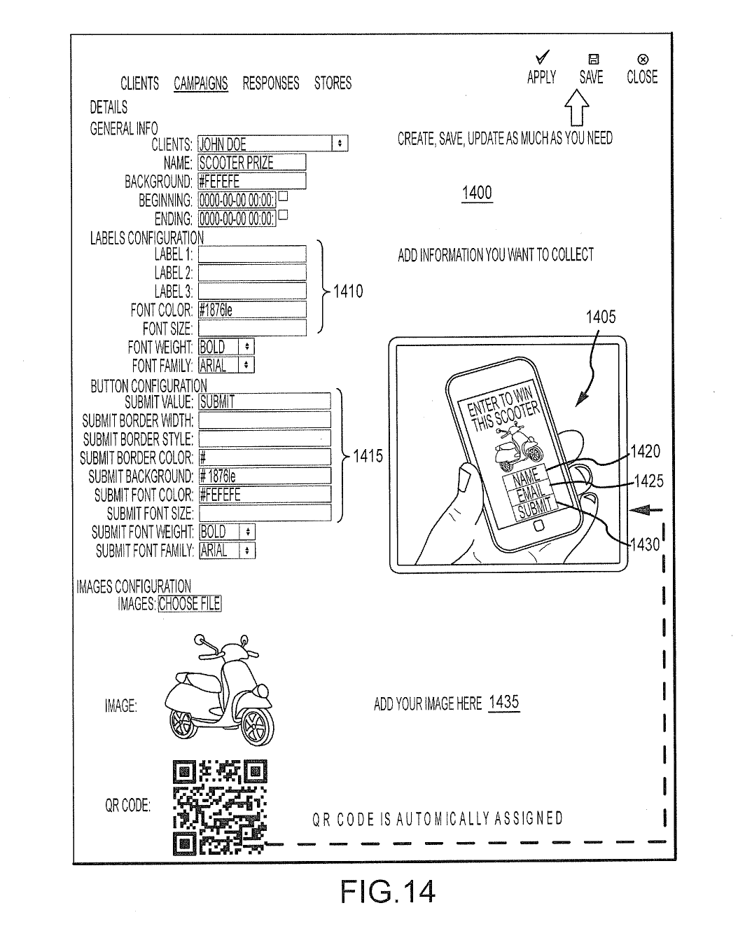

Another aspect of the present disclosure involves a mobile website 1400, such as is shown in FIG. 14, that allows a user to generate a low overhead web site 1405 with one or more preprogrammed labels 1410 and buttons 1415. A user accessing the mobile website may define various buttons that will be active on the overhead web site. For example, a name button 1420, an email button 1425, and a submit button 1430 may be defined. Further the site allows the user to post an image 1435 that will be presented on the web site. Finally, the mobile website generates a QR code 1440 or other code that is printed on a food and beverage medium.

When the QR code is scanned by a consumer, the consumer's mobile device links to the web site 1405. When the consumer then interacts with the web site 1405, such as by providing an email and hitting submit, the system may process the submission and may also collect information for the consumer. This information may be used to track the efficacy of the web site 1405, may be used to obtain consumer information and demographics, as well as other uses. The QR code and/or web site may also be associated with a cafe where the sleeve including the QR code was printed, allowing the system to track the performance and various metrics of individual cafes. Within a portal, mobile websites may be created to generate QR codes that are paired with advertising campaigns and can be directed to one or many printers.

As discussed herein, in one possible implementation, computing application is configured to track sleeve inventory and automatically generate an order when inventory is depleted to a certain level. In addition, the system facilitates generation of relevant programming so that a café owner does not have to pre-order sleeves with information that may become out-dated or expire. Hence, various aspects of the present disclosure solve a common problem generally described as the “Newsvendor Dilemma.” The Newsvendor (or Newsboy) is an analogy to the situation faced by a newspaper vendor who must decide how many copies of the day's paper to stock in the face of uncertain demand and knowing that unsold copies will be worthless at the end of the day. Aspects of the present disclosure avoid this problem.

In additional to all of the various advantages discussed herein, live programming on coffee sleeves is more sustainable than many conventional techniques of advertising, such as flyers, as it can take the place of flyers and yet convey the same type of messages on a medium that serves another purpose. Moreover, translating the message from a flyer to a sleeve, which has available space to place a message reduces the carbon footprint.

The description above includes example systems, methods, techniques, instruction sequences, and/or computer program products that embody techniques of the present disclosure. However, it is understood that the described disclosure may be practiced without these specific details. Additionally, the system may be extendable so that a user may use APIs (application programming interfaces) to write and access content and data for additional applications for the system.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for delivering targeted information to a consumer comprising:
obtaining, at a computing device associated with a printer, programming to print on a food or beverage medium;
contemporaneously with a consumer receiving a product, printing the programming on the food and beverage medium for distribution to the consumer with the product.

2. The method of claim 1 wherein the food and beverage medium comprises at least one of a beverage sleeve, a beverage coaster, a food package and an ice cream sleeve.

3. The method of claim 1 further comprising:
in response to an electronic transaction associated with a food or beverage purchase, accessing a remote server to obtain the programming to print on the food and beverage medium.

4. The method of claim 1 further comprising:
accessing a database including demographic information for the consumer;
obtaining, at the computing device associated with the printer, programming from a network server to print on the beverage sleeve based, at least in part, on the demographic information for the consumer of the beverage.

5. The method of claim 4 further comprising
obtaining a digital image of the consumer;
automatically identifying a demographic trait of the consumer from the digital image; and
accessing a database including demographic information for the consumer based, at least in part, on the demographic trait of the consumer.

6. The method of claim 1 further comprising:
accessing electronic information including geographic location information associated with the consumer; and
obtaining, at the computing device associated with the printer programming, to print on the food and beverage medium based, at least in part, on the location information for the consumer of the beverage

7. The method of claim 1 further comprising:
electronically identifying one or more characteristics of the consumer;
obtaining, using the computing device associated with the printer, programming from a programming database to print on the food or beverage medium based, at least in part, on the electronic identification of the characteristics of the consumer.

8. The method of claim 7 wherein obtaining further comprises:
obtaining at least one targeted advertising information to print on the food and beverage medium based, at least in part, on the characteristic of the consumer; and
printing the targeted advertising information on the food and beverage.

9. The method of claim 7 wherein the characteristic of the consumer includes at least one of name, age, gender, income, address, ethnicity, and geographic location.

10. The method of claim 1 wherein:
programming comprises information from a network address for a social media site.

11. The method of claim 1 further comprising:
processing an electronic payment associated with printing the programming on the food and beverage medium.

12. The method of claim 1 further comprising:
obtaining the programming to print on a beverage sleeve from a web portal accessible by a third party to define the programming to print on the beverage sleeve.

13. The method of claim 1 further comprising:
associating an electronic approval with the programming to print on the food and beverage medium.

14. The method of claim 1 wherein the programming includes at least one of a coupon, a matrix code, and a bar code.

15. The method of claim 1 further comprising:
at the computing device associated with the printer, tracking a number of food and beverage medium processed by the printer; and
sending a request for additional inventory of the food and beverage medium when the tracked number meets a threshold.

16. A system for managing information for printing on a beverage sleeve comprising:
at least one computing device in operable communication with a printer and a network, the at least one computing device configured to receive programming for the printer to print on a food and beverage medium, the at least one computing device configured to receive the programming based on a transaction proximate the printer, the at least one computing device configured to receive the programming from at least one computer accessible source of programming to print on the beverage sleeve, the at least one computer accessible source of information in operable communication with the network.

17. The system of claim 16 wherein the source of programming includes a network accessible application configured to allow a user to create the programming.

18. The system of claim 16 wherein the source of programming includes a database accessible through the network, the database storing the programming.

19. The system of claim 16 wherein the source of programming includes information obtained from a network accessible site.

20. The system of claim 16 further comprising:
at least one computing device configured to process a financial transaction for scheduling programming on the food and beverage medium.

21. The system of claim 16 further comprising
an application on a mobile computing device, the application configured to provide access to the network accessible application to allow a user of the mobile computing device to define the programming to print on the beverage sleeve.

22. The system of claim 21 wherein:
the at least one computing device is further configured to recognize when a particular consumer has purchased a food or beverage item, the network accessible application further configured to allow the user to identify the consumer and define the information to print on the beverage sleeve for the particular consumer.

23. The system of claim 17 wherein the network accessible application allows the user to schedule information to print on the beverage sleeve.

24. The system of claim 16 wherein the food and beverage medium comprises a beverage sleeve.

25. The system of claim 24 wherein the beverage sleeve includes a first station and a second station, the beverage sleeve including a first side with a fluted insulating portion and a second side with the first station and the second station, the fluted insulating portion including a pressed end portion adhered to a second pressed end portion to form a truncated conical cylinder with a substantially seamless boundary between the first station and the second station.

26. The system of the claim 25 wherein the at least one computing device is configured to allow a user to define one or more channels within which the programming is printed.

27. The system of claim 26 wherein the at least one computing device is further configured so that the user can designate at least one of the channels for use by a third party in exchange for remuneration.
